(19) United States
(12) Patent Application Publication
(10) Pub. No.: US 2002/0095687 A1
(43) Pub. Date: Jul. 18, 2002

(54) Embedded content caching for interactive television

(76) Inventors: Peter Rae Shintani, San Diego, CA (US); Matthew S. Chang, San Diego, CA (US); Aditya Krishnan, San Diego, CA (US); Andrew M. Proehl, San Francisco, CA (US); David K.L. Yang, San Jose, CA (US); Fred J. Zustak, Poway, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/760,579

(22) Filed: Jan. 16, 2001

(51) Int. Cl. H04N 7/173

(52) U.S. Cl. 725/112; 725/110; 725/109

(57) ABSTRACT

An interactive television system uses a cache memory system that mirrors pages associated with a URL embedded within the interactive content. When a subscriber chooses to download the page associated with the interactive content, a server first searches the cached pages to determine if the requested pages can be downloaded to the subscriber from cache memory. If not, the requested pages are downloaded via the Internet. In another embodiment, the cache memory can be situated at a subscriber's set-top box.

### FIELD OF THE INVENTION

This invention relates generally to the field of interactive television. More particularly, this invention relates to a method and apparatus for caching interactive content for rapid access by a user.

### BACKGROUND OF THE INVENTION

Interactive television is currently available from Wink Communications of Alameda, Calif. Other interactive television services are also expected to be available in the near future. In accordance with one expected scenario, a universal resource locator (URL) may be incorporated as interactive content within a television program. In this scenario, when the user wishes to obtain additional information associated with the URL, he or she actuates a switch on his remote controller to retrieve a web page or other content identified by the universal resource locator. A service provider then downloads the page corresponding to the URL.

In order for this process to provide a useful interactive experience to the user, it is desirable that the downloading of the page corresponding to the URL occur as quickly as possible. Accordingly, the present invention addresses this need.

### SUMMARY OF THE INVENTION

The present invention relates generally to interactive television. Objects, advantages and features of the invention will become apparent to those skilled in the art upon consideration of the following detailed description of the invention.

In one embodiment of the present invention an interactive television system uses a cache memory system that mirrors pages associated with a URL embedded within the interactive content. When a subscriber chooses to download the page associated with the interactive content, a server first searches the cached pages to determine if the requested pages can be downloaded to the subscriber from cache memory. If not, the requested pages are downloaded via the Internet. In another embodiment, the cache memory can be situated at a subscriber's set-top box.

A method of providing enhanced performance in an interactive television system consistent with embodiments of the present invention includes: scanning an interactive content bearing program for a universal resource locator (URL); upon finding a URL in the interactive content bearing program, mirroring content associated with the URL to a cache memory; presenting the interactive content bearing program to a plurality of subscribers; receiving a request from a subscriber for the URL; retrieving the mirrored content associated with the URL from the cache memory; and delivering the mirrored content associated with the URL to the subscriber.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a flow chart depicting a process used by a service provider to implement an embodiment of the present invention.

FIG. 4 is a flow chart depicting a process of receiving interactive content in accordance with an embodiment of the invention.

FIG. 5 is a flow chart depicting a process of receiving interactive content in accordance with another embodiment of the invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

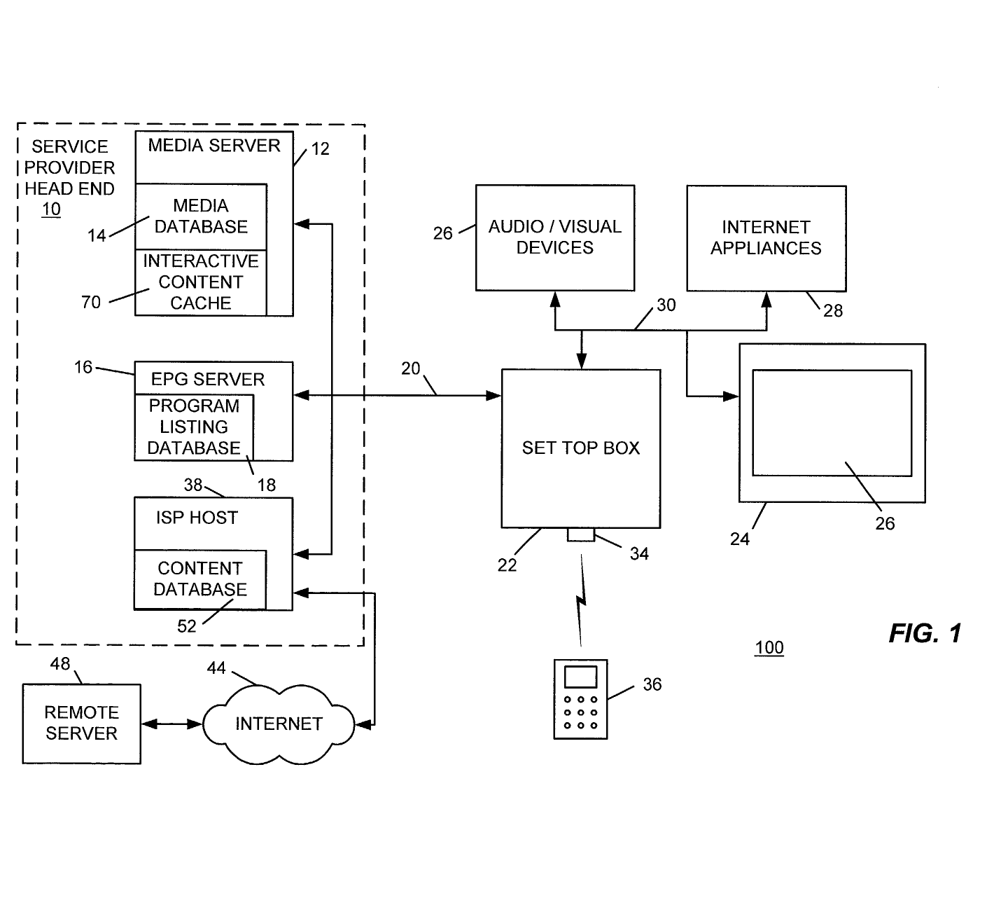

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

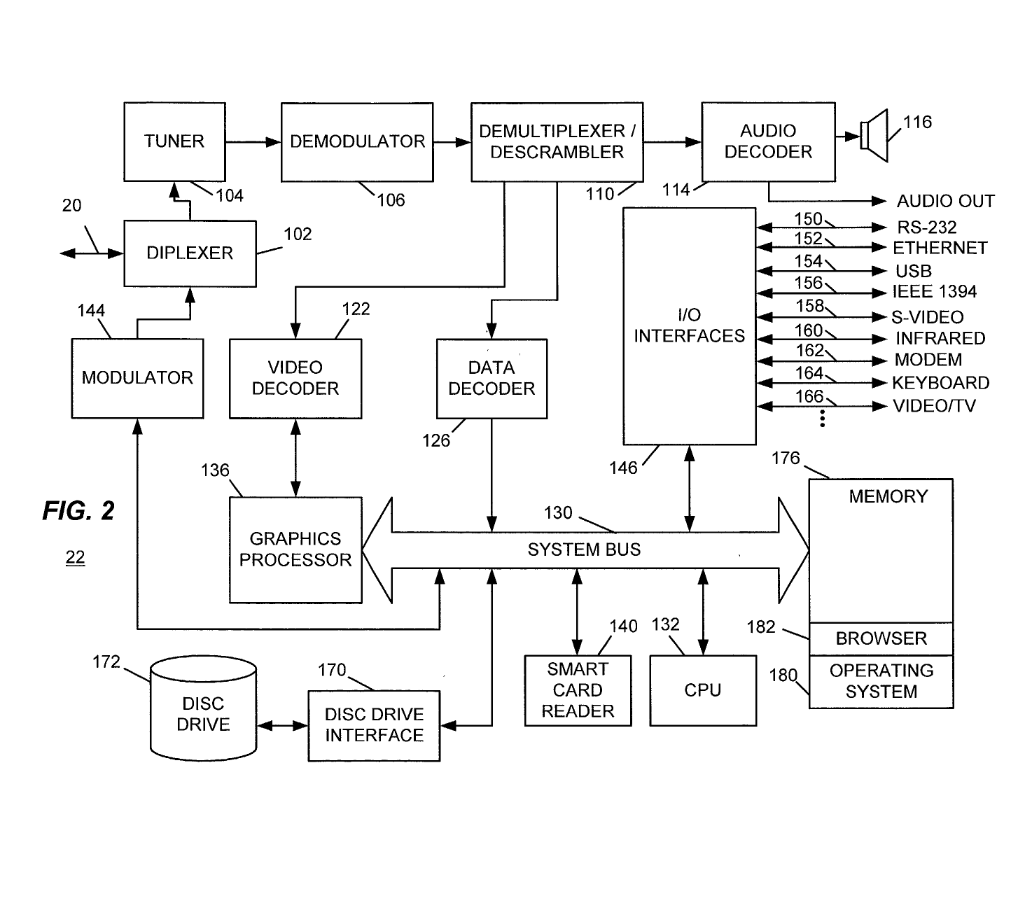

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of 1/0 (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer I descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RAM drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window - often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

Referring back to FIG. 1, in accordance with certain embodiments of the present invention, media server 12 incorporates an interactive content cache 70. Interactive content cache 70 is utilized, under program control from a processor within media server 12, to store web pages or other interactive content associated with a URL, as will be clear upon considering the foregoing description. The term “cache memory” as used herein is intended to embrace any storage device, be it silicon memory, disc storage or whatever, used as a cache without limitation.

When interactive content is delivered to a user from the service provider 10 via his set-top box 22, the interactive content may include a universal resource locator (URL) serving as a link to additional interactive content such as a web page. Upon actuating a button on remote controller 36, the user is directed to the interactive content by virtue of the interactive content associated with the URL being downloaded to the set-top box 22 for viewing by the user. In this embodiment, the user may be alerted to the presence of interactive content by virtue of being presented with various indicia on the television screen (for example an icon). Since many viewers of a particular interactive television program will likely wish to see the interactive content at approximately the same time (i.e., during or immediately after viewing the entertainment content), a data flow bottleneck can occur. Accordingly, the present invention utilizes an interactive content cache 70 to enhance the performance of the system when users are downloading content associated with a particular URL.

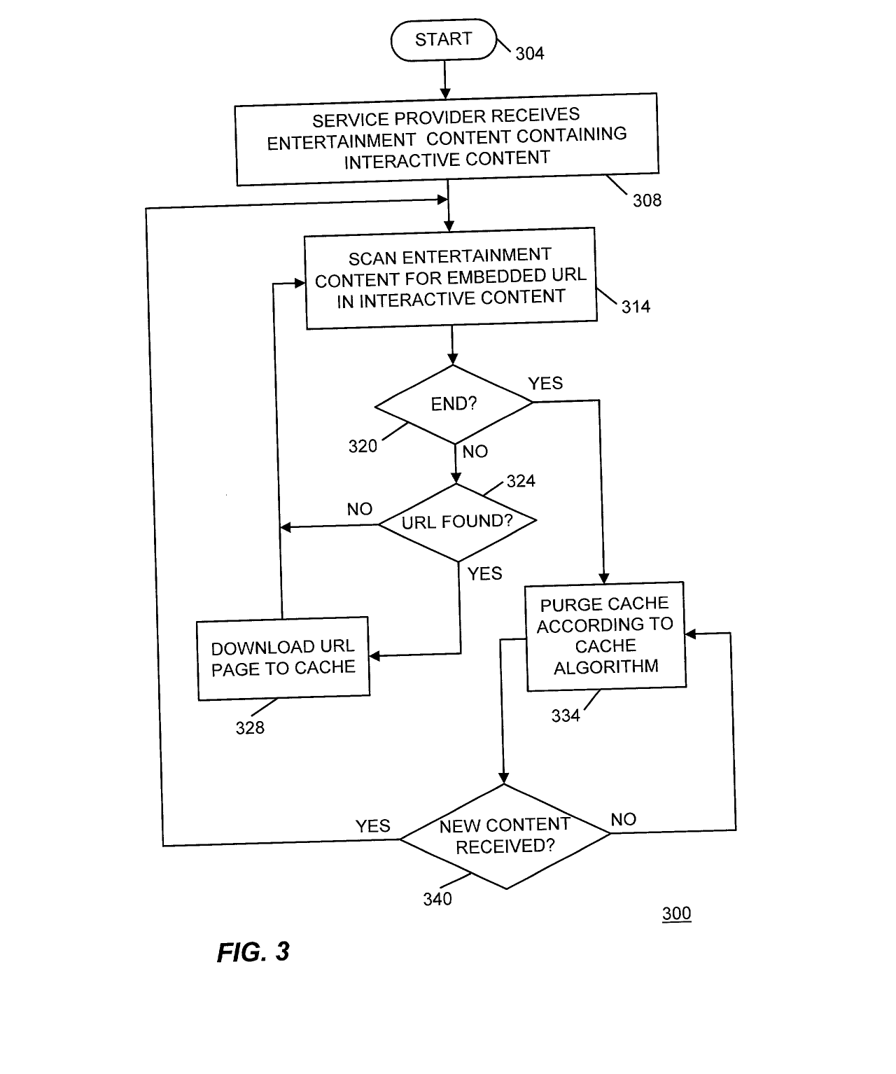

This process is illustrated in the flow chart of FIG. 3 as process 300, which can be carried out by a programmed processor residing at the service provider head end (e.g., media server 12). This process starts at 304, after which a service provider receives entertainment content containing interactive content at 308. At 314 the service provider 10 scans the entertainment content for embedded URLs in the interactive content. The scanning process continues until the end of the content is reached at 320. When a URL is found at 324, the URL is downloaded via the Internet 44 to the interactive content cache 70 at 328 and appropriately indexed for retrieval. The scanning can take place any time prior to or during presentation of the interactive content to the viewers.

Once the end of the entertainment content is reached at 320, the downloaded web pages or other content corresponding to the URLs found embedded in the interactive content are retained in the interactive content cache until needed as a result of a request from a subscriber set-top box. The interactive content cache 70 is purged in accordance with any suitable algorithm for purging a cache memory at 334. For example, the cache may be purged after a particular period of time has been reached (for example six to 12 hours, by which time most viewers of the interactive content who are interested will have already downloaded the interactive content associated with the URL). In other embodiments, the cache may be purged based upon a fixed size for the cache and in accordance with the order the information was placed in the cache (e.g., using a first in first-out algorithm). Thus, when the maximum size of the cache has been reached, the earliest stored material is discarded. In other embodiments, a least frequent use or any other suitable cache purging algorithm can be used. When new content is received at 340, the process begins again at 314.

In an extension to this concept, further pre-emptive caching can be carried out to further enhance the responsiveness of the system. In many instances, a web page or other content associated with a particular URL that appears within the television programming may lead the user to another URL embedded within the web page or other content (a secondary URL). This enhances the likelihood that a user will also wish to access the secondary URL embedded within the web page or other content. Accordingly, even further enhancement to the system's performance can be obtained by mirroring or caching sites associated with such secondary URLs. This can be done at 328 by examining the cached web page associated with the URL for secondary URLs and caching those pages, or alternatively, by caching such secondary URLs after the secondary or primary URL is accessed by a user.

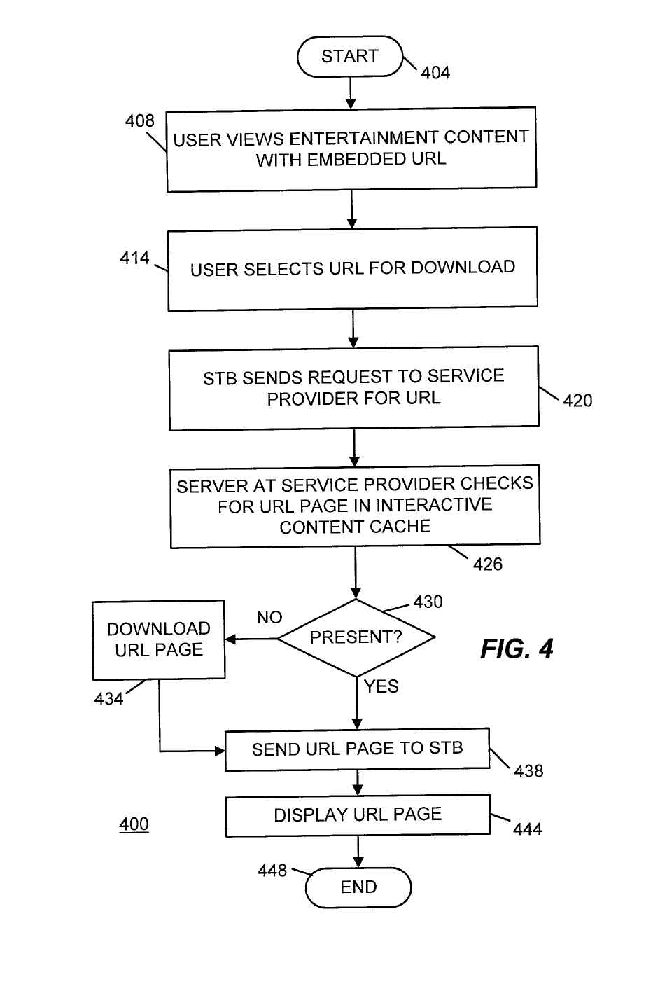

Referring now to FIG. 4, the process carried out in the current embodiment for downloading the Content associated with the URL to the user of the set-top box 22 is illustrated. This process begins at 404, after which the user views entertainment content with an embedded URL at 408. At 414 the user selects the URL for downloading, and at 422 set-top box 22 sends a request to the service provider 10 for the page or other content associated with the URL (e.g., using a cable modem). The service provider, using a programmed processor, checks for the Content associated with the URL in the interactive content cache 70 at 426. If the Content associated with the URL is present in the interactive content cache 70 at 430, the Content associated with the URL is sent to the set-top box at 438 (e.g., via cable modem), and the Content associated with the URL is displayed on display 26 at 444. The process ends at 448. In the event of the Content associated with the URL requested is not present at 430, the service provider head end downloads the Content associated with the URL from the Internet at 434, and control returns to 438. As previously described, secondary URLs can also be cached at 438 or upon access by a first user.

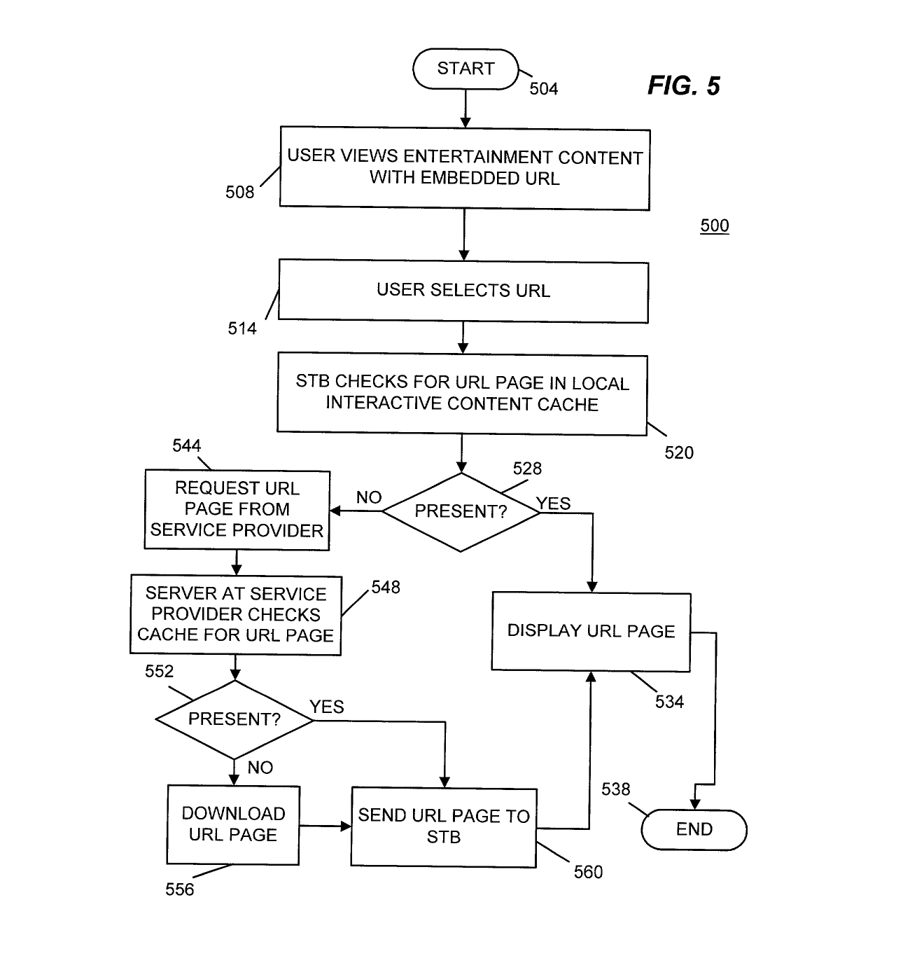

In an alternative embodiment, the URL associated with the interactive content may be stored in a local cache, for example forming a part of disk drive 172 or memory 176, of the set-top box 22. In this embodiment, process 300 as illustrated in FIG. 3 is modified only in that the downloading of the Content associated with the URL to cache at 328 is carried out to a local cache in set-top box 22. The download of the page to the STB cache can be carried out using a data channel and cable modem, for example. With reference to FIG. 5, a process 500 is illustrated in which the user retrieves selected Content associated with the URL from local cache. The process starts at 504, after which the user views entertainment content with an embedded URL at 508. At 514 the user selects the URL for display of associated information. At 522 set-top box checks for the Content associated with the URL in the local interactive content cache of, for example disk drive 172. If the Content associated with the URL is present at 528, the Content associated with the URL is displayed at 534 and the process ends at 538.

If the Content associated with the URL is not present at 528, the Content associated with the URL is requested from the service provider 10 at 544. The service provider checks the interactive content cache 70 at 548 to determine if it contains the Content associated with the URL. If it is present at 552, the Content associated with the URL is sent to the set-top box 22 at 560 for display at 534. In the event the page is not present at 552, the Content associated with the URL is downloaded to interactive content cache 70 at 556 before sending the Content associated with the URL to the set-top box 22 at 560.

Those skilled in the art will find many variations of the present invention are possible without departing from the present invention. For example, Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored on an electronic storage medium as instructions to be carried out on a programed processor. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing enhanced performance in an interactive television system, comprising:
scanning an interactive content bearing program for a universal resource locator (URL);
upon finding a URL in the interactive content bearing program, mirroring content associated with the URL to a cache memory;
presenting the interactive content bearing program to a plurality of subscribers;
receiving a request from a subscriber for the URL;
retrieving the mirrored content associated with the URL from the cache memory; and
delivering the mirrored content associated with the URL to the subscriber.

2. The method according to claim 1, further comprising purging the cache memory in accordance with a purging algorithm.

3. The method according to claim 2, wherein the purging algorithm purges the cache in accordance with an amount of time the mirrored content has been in the cache.

4. The method according to claim 2, wherein the purging algorithm purges the cache in accordance with a least frequent use algorithm.

5. The method according to claim 2, wherein the purging algorithm purges the cache in accordance with an order that the mirrored content was placed in the cache.

6. The method according to claim 1, wherein the cache memory is situated at a service provider head end.

7. The method according to claim 1, wherein the cache memory is situated at a subscriber's set-top box.

8. The method according to claim 1, further comprising determining that the URL requested by the subscriber is not in the cache memory, and downloading the interactive content associated with the URL from the Internet.

9. The method according to claim 1, further comprising:
examining the content associated with the URL for a secondary URL; and
mirroring content associated with the secondary URL to the cache memory.

10. An apparatus for providing enhanced performance in an interactive television system, comprising:
a cache memory;
program means running on a programmed processor for:
scanning an interactive content bearing program for a universal resource locator (URL);
upon finding a URL in the interactive content bearing program, mirroring content associated with the URL to the cache memory;
a media server for presenting the interactive content bearing program to a plurality of subscribers;
means for receiving a request from a subscriber for the URL;
means for retrieving the mirrored content associated with the URL from the cache memory; and
means for delivering the mirrored content associated with the URL to the subscriber.

11. The apparatus according to claim 10, wherein the program means further comprises means for purging the cache memory in accordance with a purging algorithm.

12. The apparatus according to claim 1 1, wherein the purging algorithm purges the cache in accordance with an amount of time the mirrored content has been in the cache.

13. The apparatus according to claim 11, wherein the purging algorithm purges the cache in accordance with an order that the mirrored content was placed in the cache.

14. The apparatus according to claim 10, wherein the cache memory is situated at a service provider head end.

15. The apparatus according to claim 10, wherein the cache memory is situated at a subscriber's set-top box.

16. The apparatus according to claim 10, further comprising:
means for examining the content associated with the URL for a secondary URL; and
means for mirroring content associated with the secondary URL to the cache memory.

17. A method of providing enhanced performance in an interactive television system, comprising:
scanning an interactive content bearing program for a universal resource locator (URL);
upon finding a URL in the interactive content bearing program, mirroring content associated with the URL to a cache memory situated at a service provider head end;
presenting the interactive content bearing program to a plurality of subscribers;
receiving a request from a subscriber for the URL;
retrieving the mirrored content associated with the URL from the cache memory;
delivering the mirrored content associated with the URL to the subscriber;
purging the cache memory in accordance with a purging algorithm, wherein the purging algorithm purges the cache in accordance with an amount of time the mirrored content has been in the cache memory.

18. The method according to claim 17, wherein the mirroring further comprises mirroring the content associated with the URL to a local cache memory situated at a subscriber's set-top box, and wherein the retrieving comprises retrieving the content associated with the URL to one of the cache memory and the local cache memory.

19. The method according to claim 17, further comprising determining that the URL requested by the subscriber is not in the cache memory and the local cache memory, and downloading the interactive content associated with the URL from the Internet.

20. The method according to claim 17, further comprising:
examining the content associated with the URL for a secondary URL; and
mirroring content associated with the secondary URL to the cache memory.

21. A method of providing enhanced performance in an interactive television system, comprising:
scanning an interactive content bearing program for a universal resource locator (URL);
upon finding a URL in the interactive content bearing program, mirroring content associated with the URL to a cache memory situated at a service provider head end and a local cache memory situated at a subscriber's set-top box;
presenting the interactive content bearing program to a plurality of subscribers;
receiving a request from a subscriber for the URL;
retrieving the mirrored content associated with the URL from one of the cache memory and the local cache memory;
delivering the mirrored content associated with the URL to the subscriber;
purging the cache memory in accordance with a purging algorithm, wherein the purging algorithm purges the cache in accordance with an amount of time the mirrored content has been in the cache.

22. The method according to claim 21, further comprising determining that the URL requested by the subscriber is not in the cache memory and the local cache memory, and downloading the interactive content associated with the URL from the Internet.

23. The method according to claim 21, further comprising:
examining the content associated with the URL for a secondary URL; and
mirroring content associated with the secondary URL to the cache memory.

24. A storage medium storing instructions which, when executed on a programmed processor, carry out a method of providing enhanced performance in an interactive television system, comprising:
scanning an interactive content bearing program for a universal resource locator (URL);
upon finding a URL in the interactive content bearing program, mirroring content associated with the URL to a cache memory;
presenting the interactive content bearing program to a plurality of subscribers;
receiving a request from a subscriber for the URL;
retrieving the mirrored content associated with the URL from the cache memory; and
delivering the mirrored content associated with the URL to the subscriber.

25. The storage medium according to claim 24, further comprising purging the cache memory in accordance with a purging algorithm.

26. The storage medium according to claim 24, further comprising determining that the URL requested by the subscriber is not in the cache memory, and downloading the interactive content associated with the URL from the Internet.

27. The storage medium according to claim 24, further comprising:
examining the content associated with the URL for a secondary URL; and
mirroring content associated with the secondary URL to the cache memory.
